(19) United States
(12) Patent Application Publication
(10) Pub. No.: US 2011/0116983 A1
(43) Pub. Date: May 19, 2011

(54) HONEYCOMB STRUCTURE AND EXHAUST GAS CONVERTER

(75) Inventors: Masafumi KUNIEDA, Ibi-Gun (JP); Ken YOSHIMURA, Ibi-Gun (JP)

(73) Assignee: IBIDEN CO., LTD., Ogaki-Shi (JP)

(21) Appl. No.: 12/899,548

(22) Filed: Oct. 7, 2010

(30) Foreign Application Priority Data
Nov. 19, 2009 (JP) PCT/JP2009/069659

(51) Int. Cl. B01J 29/85; B01J 31/06; B01D 50/00

(52) U.S. Cl. 422/177; 502/62

(57) ABSTRACT

A honeycomb structure includes at least one honeycomb unit. The honeycomb unit includes a first region, a second region different from the first region, an inorganic binder, and zeolite. The first region extends from one end of the honeycomb unit over approximately 30% or more and approximately 70% or less of an overall length of the honeycomb unit in the longitudinal direction. The zeolite includes a first zeolite and a second zeolite. The first zeolite is ion-exchanged with a first metal and has a mass content. The second zeolite is ion-exchanged with a second metal and has a mass content that is smaller than the mass content of the first metal in the first region and larger than the mass content of the first metal in the second region.

### CROSS-REFERENCE TO RELATED APPLICATION

The present application claims priority under 35 U.S.C. §119 to PCT International Application No. PCT/JP2009/069659, filed on Nov. 19, 2009, the entire contents of which are incorporated herein by reference.

### BACKGROUND OF THE INVENTION

1. Field of the Invention

The present invention relates to a honeycomb structure and an exhaust gas converter.

2. Description of the Related Art

Conventionally, the SCR (Selective Catalytic Reduction) system, which reduces NOx to nitrogen and water using ammonia, is known as one of the systems for converting automobile exhaust gas.

Further, zeolite is known as a material that adsorbs ammonia in the SCR system.

JP9-103653A discloses, as a method of converting NOx into a harmless product, preparing iron-containing ZSM-5 zeolite of an iron content of approximately 1 to 5 wt % and causing the zeolite to come into contact with a workstream containing NOx in the presence of ammonia at a temperature of at least approximately 200° C.

Further, WO 06/137149 A1 discloses a honeycomb structure where a honeycomb unit contains inorganic particles and inorganic fibers and/or whiskers, the inorganic particles being one or more selected from the group consisting of alumina, silica, zirconia, titania, ceria, mullite, and zeolite.

The entire contents of JP9-103653A and WO 06/137149 A1 are incorporated herein by reference.

### SUMMARY OF THE INVENTION

According to one aspect of the present invention, a honeycomb structure includes at least one honeycomb unit. The at least one honeycomb unit has a plurality of through holes defined by partition walls along a longitudinal direction of the honeycomb unit. The at least one honeycomb unit includes a first region, a second region, an inorganic binder, and zeolite. The first region extends from one end of the honeycomb unit over approximately 30% or more and approximately 70% or less of an overall length of the honeycomb unit in the longitudinal direction. The second region is different from the first region. The zeolite includes a first zeolite and a second zeolite. The first zeolite is ion-exchanged with a first metal including at least one of Cu, Mn, and Ag and has a mass content. The second zeolite is ion-exchanged with a second metal including at least one of Fe, Ti, and Co. The second metal has a mass content that is smaller than the mass content of the first metal in the first region and larger than the mass content of the first metal in the second region.

According to another aspect of the present invention, an exhaust gas converter includes the honeycomb structure according to the one aspect of the present invention.

### BRIEF DESCRIPTION OF THE DRAWINGS

Other objects, features and advantages of the present invention will become more apparent from the following detailed description when read in conjunction with the accompanying drawings, in which:

FIG. 1 is a perspective view of a honeycomb structure according to an embodiment of the present invention;

FIG. 2 is a cross-sectional view of an exhaust gas converter according to the embodiment of the present invention;

FIG. 3 is a perspective view of a variation of the honeycomb structure according to the embodiment of the present invention; and

FIG. 4 is a perspective view of a honeycomb unit of the honeycomb structure of FIG. 3 according to the embodiment of the present invention.

### DETAILED DESCRIPTION OF THE EMBODIMENTS

In the case of using a conventional honeycomb structure containing zeolite ion-exchanged with Fe in the SCR system, there is the problem of a lower NOx conversion rate than is expected from the amount of zeolite contained in the honeycomb structure. It is believed that this is because automobile exhaust gas generally has a wide temperature range of approximately 150° C. to approximately 750° C., which includes a temperature range where the NOx conversion performance of the zeolite ion-exchanged with Fe is insufficient.

According to an embodiment of the present invention, it is possible to obtain a honeycomb structure and an exhaust gas converter capable of improving the NOx conversion rate in the SCR system.

Next, a description is given with the drawings of an embodiment of the present invention.

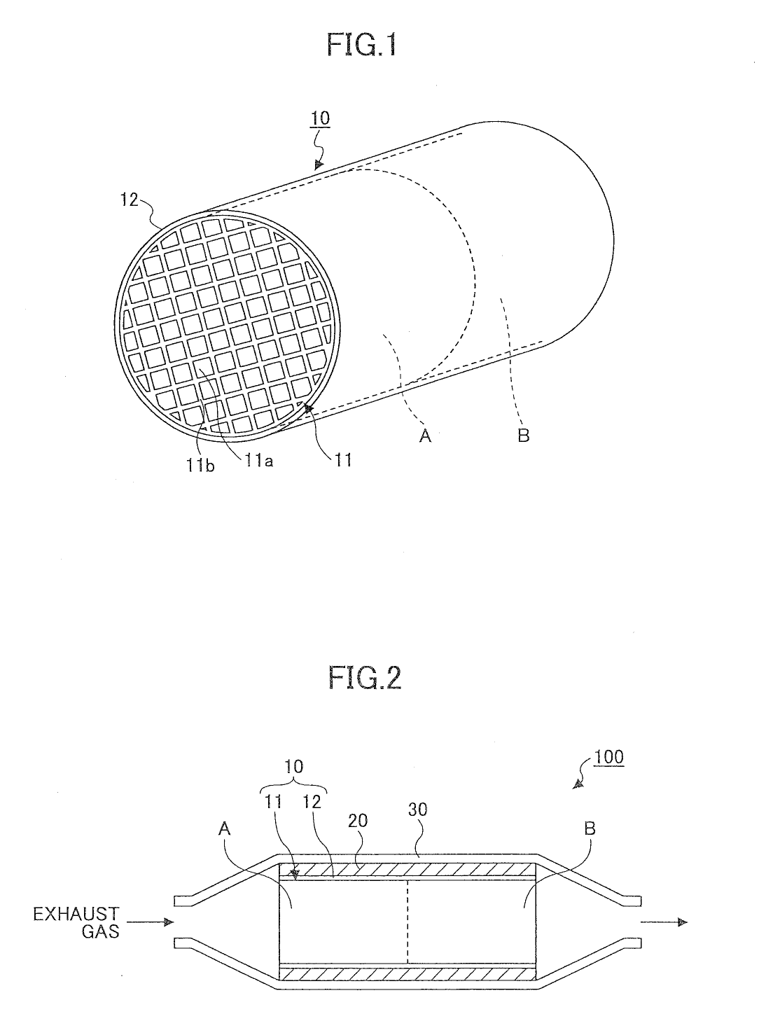

FIG. 1 illustrates a honeycomb structure according to an embodiment of the present invention, and FIG. 2 illustrates an exhaust gas converter according to the embodiment of the present invention. A honeycomb structure 10 includes a single honeycomb unit 11 containing zeolite and an inorganic binder. The honeycomb unit 11 has multiple through holes 11a defined by partition walls along a longitudinal direction of the honeycomb unit 11b. The honeycomb structure 10 further includes a peripheral coat layer 12 formed on the peripheral surface of the honeycomb unit 11.

The zeolite includes first zeolite ion-exchanged with a first metal and second zeolite ion-exchanged with a second metal. The first metal is at least one of Cu, Mn, Ag, and V. The second metal is at least one of Fe, Ti, and Co. The zeolite may further include zeolite subjected to no ion exchange and/or zeolite ion-exchanged with a metal other than those described above.

In the honeycomb unit 11, the mass content of the first metal is more than the mass content of the second metal in a first region A, which extends from one end of the honeycomb unit 11 in its longitudinal direction for approximately 30% to approximately 70% of its overall length, and the mass content of the second metal is more than the mass content of the first metal in a second region B, which is the other region different from the first region A.

The boundary between the first region A and the second region B of the honeycomb unit 11 is a plane across which the mass content of the first metal and the mass content of the second metal, measured by conducting ICP emission spectrometry, are inverted. If there is a region where the mass content of the first metal and the mass content of the second metal are substantially equal, the middle position of the region where the first and second metals are substantially equal in mass content is determined as the boundary between the first region A and the second region B.

On the other hand, generally, automobile exhaust gas has a wide temperature range of approximately 150° C. to approximately 750° C. Therefore, exhaust gas converters are desired to be high in NOx conversion performance in both a low temperature range (for example, approximately 150° C. to approximately 250° C.) and a high temperature range (approximately 500° C. or more).

It is believed that the first zeolite ion-exchanged with the first metal is high in NOx conversion performance in the low temperature range and the second zeolite ion-exchanged with the second metal is high in NOx conversion performance in the high temperature range. Accordingly, an exhaust gas converter 100 (FIG. 2) having the honeycomb structure 10 is believed to be high in NOx conversion performance in both the low temperature range and the high temperature range.

As illustrated in FIG. 2, it is preferable to have the second region B positioned on the downstream side in a direction in which exhaust gas flows in the honeycomb unit 11. The NOx conversion rate is likely to be lower in the case of positioning the second region B on the upstream side in the exhaust gas flowing direction in the honeycomb unit 11 than in the case of positioning the second region B on the downstream side in the exhaust gas flowing direction in the honeycomb unit 11. It is believed that this is because the second zeolite ion-exchanged with the second metal, which is believed to be high in NOx conversion performance in the high temperature range, is generally reduced in NOx conversion performance at or beyond approximately 500° C. The exhaust gas tends to be lower in temperature on the downstream side than on the upstream side in the exhaust gas flowing direction of the exhaust gas converter 100. Therefore, it is believed to be easier to prevent reduction in the NOx conversion performance of the second zeolite ion-exchanged with the second metal by positioning the second region B on the downstream side in the exhaust gas flowing direction in the honeycomb unit 11.

The exhaust gas converter 100 is obtained by canning the honeycomb structure 10 into a metal pipe 30 with a holding sealing member 20 provided around the honeycomb structure 10. Further, an ejecting part (not graphically illustrated) such as an eject nozzle to eject ammonia or its precursor is provided on the upstream side of the honeycomb structure 10 in the exhaust gas flowing direction in the exhaust gas converter 100. As a result, ammonia is added to the exhaust gas, so that NOx contained in the exhaust gas is reduced on the zeolite contained in the honeycomb unit 11. Considering the stability of storage of ammonia or its precursor, it is preferable to use urea water as a precursor of ammonia. Urea water is hydrolyzed by being heated in exhaust gas so as to generate ammonia.

In the first region A of the honeycomb unit 11, the ratio of the mass of the first metal to the total mass of the first metal and the second metal is preferably approximately 0.80 to approximately 1.00, and more preferably, approximately 0.90 to approximately 1.00. If this ratio is approximately 0.80 or more, the NOx conversion rate is less likely to be reduced.

In the second region B of the honeycomb unit 11, the ratio of the mass of the second metal to the total mass of the first metal and the second metal is preferably approximately 0.80 to approximately 1.00, and more preferably, approximately 0.90 to approximately 1.00. If this ratio is approximately 0.80 or more, the NOx conversion rate is less likely to be reduced.

In the honeycomb unit 11, it is preferable that the amount of ion exchange of the first zeolite ion-exchanged with the first metal and the amount of ion exchange of the second zeolite ion-exchanged with the second metal be independently approximately 1.0 mass % to approximately 5.0 mass %. If the amount of ion exchange is approximately 1.0 mass % or more, the NOx conversion performance is less likely to be insufficient. On the other hand, if the amount of ion exchange is approximately 5.0 mass % or less, metal to be subjected to ion exchange is less likely to be present as an oxide, so that it is less likely that the metal is less susceptible to ion exchange.

Zeolite is not limited in particular, and may be β-zeolite, zeolite ZSM-5, phosphate-based zeolite, etc. Two or more of them may be used together. Of these, phosphate-based zeolite, whose NOx conversion performance is high, is preferable.

Examples of phosphate-based zeolite include SAPOs such as a SAPO-5, a SAPO-11, and a SAPO-34, MeAPOs, and MeAPSOs.

The average particle size of the primary particles or secondary particles of zeolite is preferably approximately 0.5 μm to approximately 10 μm, and more preferably, approximately 1 μm to approximately 5 μm. If the primary particles or secondary particles of zeolite are approximately 0.5 μm or more in average particle size, exhaust gas is likely to penetrate into the partition walls 11b, so that zeolite is likely to be used effectively for NOx conversion. On the other hand, if the primary particles or secondary particles of zeolite are approximately 10 μm or less in average particle size, the number of pores in the honeycomb unit 11 is less likely to be reduced. As a result, exhaust gas is likely to penetrate into the partition walls 11b, so that zeolite is likely to be used effectively for NOx conversion.

The zeolite content per apparent volume of the honeycomb unit 11 is preferably approximately 230 g/L to approximately 360 g/L. If the zeolite content per apparent volume of the honeycomb unit 11 is approximately 230 g/L or more, it is unnecessary to increase the apparent volume of the honeycomb unit 11 in order to improve the NOx conversion rate. On the other hand, if the zeolite content per apparent volume of the honeycomb unit 11 is approximately 360 g/L or less, the strength of the honeycomb unit 11 is less likely to be insufficient.

The inorganic binder contained in the honeycomb unit 11 is not limited in particular, and may be a solids content contained in alumina sol, silica sol, titania sol, water glass, sepiolite, attapulgite, boehmite, etc. Two or more of them may be used together.

The inorganic binder content of the honeycomb unit 11 is preferably approximately 5 mass % to approximately 30 mass % as a solids content, and more preferably, approximately 10 mass % to approximately 20 mass % as a solids content. If the inorganic binder content is approximately 5 mass % or more as a solids content, the strength of the honeycomb unit 11 is less likely to be reduced. On the other hand, if the inorganic binder content is approximately 30 mass % or less as a solids content, it is less likely to be difficult to perform extrusion molding of the honeycomb unit 11.

It is preferable that the honeycomb unit 11 further include inorganic fibers and/or flakes.

The inorganic fibers contained in the honeycomb unit 11 are not limited in particular as long as the inorganic fibers can increase the strength of the honeycomb unit 11, and may be alumina, silica, silicon carbide, silica alumina, glass, potassium titanate, aluminum borate, etc. Two or more of them may be used together.

The aspect ratio of the inorganic fibers is preferably approximately 2 to approximately 1000, more preferably approximately 5 to approximately 800, and still more preferably approximately 10 to approximately 500. If the aspect ratio is approximately 2 or more, the effect of increasing the strength of the honeycomb unit 11 is less likely to be reduced. On the other hand, if the aspect ratio is approximately 1000 or less, clogging is less likely to occur in a die at the time of the extrusion molding of the honeycomb unit 11 or the inorganic fibers is less likely to break, so that the effect of increasing the strength of the honeycomb unit 11 is less likely to be reduced.

The flakes contained in the honeycomb unit 11 are not limited in particular as long as the flakes can increase the strength of the honeycomb unit 11, and may be glass, muscovite, alumina, silica, zinc oxide, etc. Two or more of them may be used together.

The inorganic fibers and flakes content of the honeycomb unit 11 is preferably approximately 3 mass % to approximately 50 mass %, more preferably approximately 3 mass % to approximately 30 mass %, and still more preferably approximately 5 mass % to approximately 20 mass %. If the inorganic fibers and flakes content is approximately 3 mass % or more, the effect of increasing the strength of the honeycomb unit 11 is less likely to be reduced. On the other hand, if the inorganic fibers and flakes content is approximately 50 mass % or less, the zeolite content of the honeycomb unit 11 is less likely to decrease so that the NOx conversion rate is less likely to be reduced.

The honeycomb unit 11 preferably has a porosity of approximately 25% to approximately 40%. If the porosity of the honeycomb unit 11 is approximately 25% or more, exhaust gas is likely to penetrate into the partition walls 11b, so that zeolite is likely to be used effectively for NOx conversion. On the other hand, if the porosity of the honeycomb unit 11 is approximately 40% or less, the strength of the honeycomb unit 11 is less likely to be insufficient.

The porosity may be measured using mercury intrusion porosimetry.

The honeycomb unit 11 preferably has an opening ratio of approximately 50% to approximately 75% in a cross section perpendicular to its longitudinal direction. If the opening ratio of the cross section perpendicular to the longitudinal direction of the honeycomb unit 11 is approximately 50% or more, zeolite is likely to be used effectively for NOx conversion. On the other hand, if the opening ratio of the cross section perpendicular to the longitudinal direction of the honeycomb unit 11 is approximately 75% or less, the strength of the honeycomb unit 11 is less likely to be insufficient.

The density of the through holes 11a of the honeycomb unit 11 in a cross section perpendicular to its longitudinal direction is preferably approximately 31 cells/cm² to approximately 124 cells/cm². If the density of the through holes 11a of the cross section perpendicular to the longitudinal direction of the honeycomb unit 11 is approximately 31 cells/cm² or more, exhaust gas and zeolite are likely to make contact, so that the NOx conversion rate is less likely to be reduced. On the other hand, if the density of the through holes 11a of the cross section perpendicular to the longitudinal direction of the honeycomb unit 11 is approximately 124 cells/cm² or less, the pressure loss of the honeycomb structure 10 is less likely to increase.

The partition walls 11b of the honeycomb unit 11 are preferably approximately 0.10 mm to approximately 0.50 mm, and more preferably, approximately 0.15 mm to approximately 0.35 mm in thickness. If the partition walls 11b are approximately 0.10 mm or more in thickness, the strength of the honeycomb unit 11 is less likely to be reduced. On the other hand, if the partition walls 11b are approximately 0.50 mm or less in thickness, exhaust gas is likely to penetrate into the partition walls 11b, so that zeolite is likely to be used effectively for NOx conversion.

The peripheral coat layer 12 is preferably approximately 0.1 mm to approximately 2 mm in thickness. If the peripheral coat layer 12 is approximately 0.1 mm or more in thickness, the effect of increasing the strength of the honeycomb structure 10 is less likely to be insufficient. On the other hand, if the peripheral coat layer 12 is approximately 2 mm or less in thickness, the zeolite content per unit volume of the honeycomb structure 10 is less likely to be reduced, so that the NOx conversion rate is less likely to be reduced.

The honeycomb structure 10, which has a substantially cylindrical shape, is not limited to a particular shape, and may have a substantially rectangular pillar shape, a substantially cylindroid shape, etc. Further, the through holes 11a, which have a substantially quadrangular pillar shape, are not limited to a particular shape, and may have a substantially triangular pillar shape, a substantially hexagonal pillar shape, etc.

Next, a description is given of a method of manufacturing the honeycomb structure 10 of the embodiment of the present invention. First, a raw substantially cylindrical honeycomb molded body having multiple through holes defined by partition walls along a longitudinal direction of the honeycomb unit is manufactured by extrusion molding using raw material paste including zeolite and an inorganic binder and further including inorganic fibers and/or flakes as required. This allows the substantially cylindrical honeycomb unit 11 with sufficient strength to be obtained even with low firing temperatures.

The inorganic binder included in the raw material paste is added as alumina sol, silica sol, titania sol, water glass, sepiolite, attapulgite, boehmite, etc. Two or more of them may be used together.

An organic binder, a dispersion medium, a molding aid, etc., may be suitably added to the raw material paste as required.

The organic binder is not limited in particular, and may be methylcellulose, carboxymethylcellulose, hydroxyethylcellulose, polyethylene glycol, phenolic resin, epoxy resin, etc. Two or more of them may be used together. The amount of addition of the organic binder is preferably approximately 1% to approximately 10% of the total mass of zeolite, an inorganic binder, inorganic fibers and flakes.

The dispersion medium is not limited in particular, and may be water, an organic solvent such as benzene, alcohol such as methanol, etc. Two or more of them may be used together.

The molding aid is not limited in particular, and may be ethylene glycol, dextrin, a fatty acid, fatty acid soap, polyalcohol, etc. Two or more of them may be used in particular.

It is preferable to mix and knead the raw material paste in its preparation. The raw material paste may be mixed using a mixer, an attritor or the like, and may be kneaded using a kneader or the like.

Next, the obtained honeycomb molded body is dried using one or more drying apparatus such as a microwave drying apparatus, a hot air drying apparatus, a dielectric drying apparatus, a reduced-pressure drying apparatus, a vacuum drying apparatus, and a freeze drying apparatus.

Further, the obtained dried honeycomb molded body is degreased. The conditions for degreasing, which are not limited in particular and may be selected suitably in accordance with the kind and the amount of organic matter included in the molded body, are preferably approximately 400° C. and approximately 2 hours.

Next, the substantially cylindrical honeycomb unit 11 is so constructed as to be obtained by firing the obtained degreased honeycomb molded body. The firing temperature is preferably approximately 600° C. to approximately 1200° C., and more preferably approximately 600° C. to approximately 1000° C. It the firing temperature is approximately 600° C. or more, sintering is likely to progress so that the strength of the honeycomb unit 11 is less likely to be reduced. On the other hand, if the firing temperature is approximately 1200° C. or less, sintering does not progress excessively so that the reaction sites of zeolite is less likely to be reduced.

Next, peripheral coat layer paste is applied on the peripheral surface of the substantially cylindrical honeycomb unit 11.

The peripheral coat layer paste is not limited in particular, and may be a mixture of an inorganic binder and inorganic particles, a mixture of an inorganic binder and inorganic fibers, and a mixture of an inorganic binder, inorganic particles, and inorganic fibers, etc.

The peripheral coat layer paste may further contain an organic binder. The organic binder is not limited in particular, and may be polyvinyl alcohol, methylcellulose, ethylcellulose, carboxymethylcellulose, etc. Two or more of them may be used together.

Next, the honeycomb unit 11 with the peripheral coat layer paste applied is dried and solidified so that the substantially cylindrical honeycomb structure 10 is obtained. At this point, it is preferable to perform degreasing if the peripheral coat layer paste includes an organic binder. The conditions for degreasing, which may be suitably selected in accordance with the kind and the amount of the organic binder, are preferably approximately 700° C. and approximately 20 minutes.

The zeolite of the honeycomb unit 11 may be subjected to ion exchange by immersing the first region A and the second region B of the honeycomb unit 11 in an aqueous solution containing cations of the first metal and an aqueous solution containing cations of the second metal, respectively. At this point, the entire region of the honeycomb unit 11 may be immersed in the aqueous solution containing cations of the first metal (or cations of the second metal), and thereafter, the second region B (or the first region A) may be immersed in the aqueous solution containing cations of the second metal (or cations of the first metal).

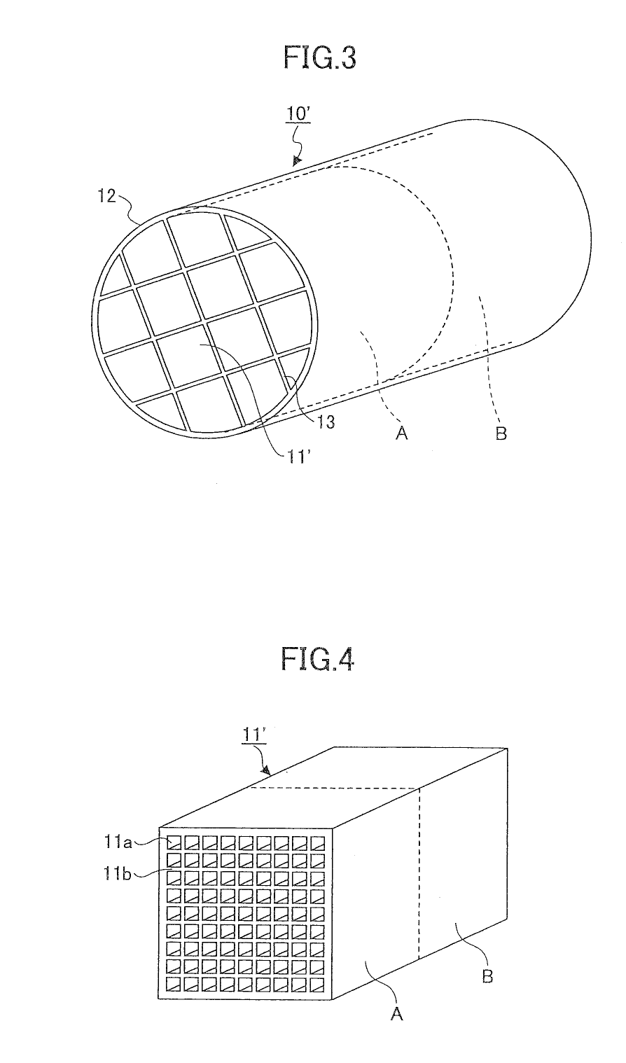

FIG. 3 illustrates a variation of the honeycomb structure 10 of the embodiment of the present invention. A honeycomb structure 10′ is the same as the honeycomb structure 10 except that multiple honeycomb units 11′ (FIG. 4) having the multiple through holes 11a provided side by side along a longitudinal direction across the partition walls 11b are bonded with an adhesive layer 13 interposed between the honeycomb units 11′.

Referring to FIG. 4, the honeycomb unit 11′ preferably has a cross-sectional area of approximately 5 cm² to approximately 50 cm² in a cross section perpendicular to its longitudinal direction. If the cross-sectional area of the cross section perpendicular to the longitudinal direction of the honeycomb unit 11′ is approximately 5 cm² or more, the pressure loss of the honeycomb structure 10′ is less likely to increase. On the other hand, if the cross-sectional area of the cross section perpendicular to the longitudinal direction of the honeycomb unit 11′ is approximately 50 cm² or less, the strength of the honeycomb unit 11′ against a thermal stress generated in the honeycomb unit 11′ is less likely to be insufficient.

The adhesive layer 13 is preferably approximately 0.5 mm to approximately 2 mm in thickness. If the adhesive layer 13 is approximately 0.5 mm or more in thickness, the strength of adhesion is less likely to be insufficient. On the other hand, if the adhesive layer 13 is approximately 2 mm or less in thickness, the pressure loss of the honeycomb structure 10′ is less likely to increase.

The honeycomb unit 11′, if not positioned in the peripheral portion of the honeycomb structure 10′, has a substantially rectangular pillar shape, but is not limited to a particular shape and may have, for example, a substantially hexagonal pillar shape or the like.

Next, a description is given of a method of manufacturing the honeycomb structure 10′ of the embodiment of the present invention. First, the substantially quadrangular-pillar-shaped honeycomb units 11′ are manufactured in the same manner as the honeycomb unit 11 of the honeycomb structure 10. Next, adhesive layer paste is applied on peripheral surfaces of the honeycomb units 11′, and the honeycomb units 11′ are successively bonded. Then, the honeycomb units 11′ are dried and solidified, so that an aggregate of the honeycomb units 11′ is manufactured.

At this point, the aggregate of the honeycomb units 11′ may be cut into a substantially cylindrical shape and ground after its manufacture. The aggregate of the honeycomb units 11′ having a substantially cylindrical shape may be manufactured by bonding honeycomb units 11′ whose cross sections are substantially fan-shaped and honeycomb units 11′ whose cross sections are substantially square.

The adhesive layer paste is not limited in particular, and may be a mixture of an inorganic binder and inorganic particles, a mixture of an inorganic binder and inorganic fibers, and a mixture of an inorganic binder, inorganic particles, and inorganic fibers, etc.

The adhesive layer paste may contain an organic binder. The organic binder is not limited in particular, and may be polyvinyl alcohol, methylcellulose, ethylcellulose, carboxymethylcellulose, etc. Two or more of them may be used together.

Next, peripheral coat layer paste is applied on the peripheral surface of the substantially cylindrical aggregate of the honeycomb units 11′. The peripheral coat layer paste is not limited in particular, and may contain the same materials as or different materials from the adhesive layer paste. The peripheral coat layer paste may have substantially the same composition as the adhesive layer paste.

Next, the aggregate of the honeycomb units 11′ having the peripheral coat layer paste applied is dried and solidified so that the substantially cylindrical honeycomb structure 10′ is obtained. At this point, it is preferable to perform degreasing if the adhesive layer paste and/or the peripheral coat layer paste includes an organic binder. The conditions for degreasing, which may be suitably selected in accordance with the kind and the amount of the organic binder, are preferably approximately 700° C. and approximately 20 minutes.

The honeycomb structures 10 and 10′ may be without the peripheral coat layer 12.

### EXAMPLES

### Example 1

First, raw material paste 1 was prepared by mixing and kneading 3100 g of a SAPO of 3 μm in average particle size, 895 g of boehmite, 485 g of alumina fibers of 6 μm in average fiber diameter and 100 μm in average fiber length, 380 g of methylcellulose, 280 g of an oleic acid, and 2425 g of ion-exchanged water.

Next, the raw material paste 1 was subjected to extrusion molding using an extruder, so that raw honeycomb molded bodies of a square pillar shape were manufactured. Then, the honeycomb molded bodies were dried at 110° C. for 10 minutes using a microwave drying apparatus and a hot air drying apparatus, and were thereafter degreased at 400° C. for 5 hours. Next, the degreased honeycomb molded bodies were fired at 700° C. for 2 hours, so that honeycomb units 11′ having a square pillar shape of 34.3 mm square and 150 mm in length were manufactured. The honeycomb units 11′ had a through hole 11a density of 93 cells/cm² and a partition wall 11b thickness of 0.23 mm.

Next, the SAPO was subjected to ion exchange by successively immersing one end portion and the other end portion of each of the honeycomb units 11′ in an aqueous copper nitrate solution and an aqueous ferric nitrate solution, respectively.

According to an ICP emission spectrometry using an ICPS-8100 (manufactured by Shimadzu Corporation), the volume ratio of the first region A and the second region B of the honeycomb unit 11′ was 1:1. Further, the amounts of ion exchange of the SAPO in the first region A and the second region B were 2.7 mass % each. In each of the first region A and the second region B of the honeycomb unit 11′, the amount of ion exchange of the SAPO was measured in a region from the end that was 25% or less of the overall length of the honeycomb unit 11′ in its longitudinal direction because the SAPO ion-exchanged with Cu ions and the SAPO ion-exchanged with Fe ions might be included around the boundary between the first region A and the second region B. Further, in the first region A, the ratio of the mass of Cu to the total mass of Cu and Fe was 1, and in the second region B, the ratio of the mass of Fe to the total mass of Cu and Fe was 1.

Next, heat-resisting adhesive layer paste was prepared by mixing and kneading 767 g of alumina fibers of 0.5 μm in average fiber diameter and 15 μm in average fiber length, 2500 g of silica glass, 17 g of carboxymethylcellulose, 600 g of silica sol of a solids content of 30 wt %, 167 g of polyvinyl alcohol, 167 g of a surfactant, and 17 g of alumina balloons.

The adhesive layer paste was applied so as to have an adhesive layer of 2 mm in thickness, and 16 honeycomb units 11′ were bonded. After drying and solidifying the adhesive layer paste at 150° C. for 10 minutes, the honeycomb units 11′ were cut into a cylindrical shape using a diamond cutter so that its cross section perpendicular to a longitudinal direction was substantially symmetrical with respect to a point, thereby manufacturing an aggregate of the honeycomb units 11′.

Further, the adhesive layer paste was applied on the peripheral surface of the aggregate of the honeycomb units 11′ so as to have a peripheral coat layer of 1 mm in thickness. Thereafter, the adhesive layer paste was dried and solidified at 150° C. for 10 minutes using a microwave drying apparatus and a hot air drying apparatus, and was degreased at 400° C. for 2 hours, so that a cylindrical honeycomb structure 10′ of 143.8 mm in diameter and 150 mm in length was manufactured.

Next, the honeycomb structure 10′ was canned in the metal pipe (shell) 30 with the holding sealing member 20 (a mat formed of inorganic fibers) provided around the honeycomb structure 10′, thereby manufacturing an exhaust gas converter (see FIG. 2). At this point, the first regions A of the honeycomb units 11′ included in the honeycomb structure 10′ were positioned on the upstream side in the exhaust gas flowing direction.

### Example 2

A honeycomb structure 10′ and an exhaust gas converter were manufactured in the same manner as in Example 1 except that the volume ratio of the first region A and the second region B of each of the honeycomb units 11′ was changed to 7:3.

### Example 3

A honeycomb structure 10′ and an exhaust gas converter were manufactured in the same manner as in Example 1 except that the volume ratio of the first region A and the second region B of each of the honeycomb units 11′ was changed to 3:7.

### Example 4

Raw material paste 2 was prepared by mixing and kneading 3000 g of β-zeolite of 3 μm in average particle size, 840 g of boehmite, 650 g of alumina fibers of 6 μm in average fiber diameter and 100 μm in average fiber length, 330 g of methylcellulose, 330 g of an oleic acid, and 1800 g of ion-exchanged water.

A honeycomb structure 10′ and an exhaust gas converter were manufactured in the same manner as in Example 1 except for using the raw material paste 2 in place of the raw material paste 1.

### Example 5

A honeycomb structure 10′ and an exhaust gas converter were manufactured in the same manner as in Example 4 except that the volume ratio of the first region A and the second region B of each of the honeycomb units 11′ was changed to 7:3.

### Example 6

A honeycomb structure 10′ and an exhaust gas converter were manufactured in the same manner as in Example 4 except that the volume ratio of the first region A and the second region B of each of the honeycomb units 11′ was changed to 3:7.

### Example 7

A honeycomb structure 10′ and an exhaust gas converter were manufactured in the same manner as in Example 1 except that the first regions A of the honeycomb units 11′ included in the honeycomb structure 10′ were positioned on the downstream side in the exhaust gas flowing direction.

### Comparative Example 1

A honeycomb structure and an exhaust gas converter were manufactured in the same manner as in Example 1 except that the volume ratio of the first region A and the second region B of each honeycomb unit was changed to 10:0.

The honeycomb structures and the honeycomb units of Comparative Example 1 and the following comparative examples are not assigned reference numerals in order to distinguish them from the honeycomb structure 10′ and the honeycomb units 11′ according to the embodiment of the present invention.

### Comparative Example 2

A honeycomb structure and an exhaust gas converter were manufactured in the same manner as in Example 4 except that the volume ratio of the first region A and the second region B of each honeycomb unit was changed to 0:10.

### Comparative Example 3

A honeycomb structure and an exhaust gas converter were manufactured in the same manner as in Example 1 except that the volume ratio of the first region A and the second region B of each honeycomb unit was changed to 8:2.

### Comparative Example 4

A honeycomb structure and an exhaust gas converter were manufactured in the same manner as in Example 4 except that the volume ratio of the first region A and the second region B of each honeycomb unit was changed to 2:8.

### [Measurement of NOx Conversion Rate]

Samples for evaluation were obtained from the honeycomb structures 10′ manufactured in Examples 1 through 7 by cutting out portions (34.3 mm square and 40 mm in length) of their respective square-pillar-shaped honeycomb units 11′ so that the volume ratio of the first region A and the second region B was 1:1 and from the honeycomb structures manufactured in Comparative Examples 1 through 4 by cutting out portions (34.3 mm square and 40 mm in length) of their respective square-pillar-shaped honeycomb units so that the volume ratio of the first region A and the second region B was 1:1.

With respect to each of the samples for evaluation, the outflow of nitrogen monoxide (NO) flowing out of the sample for evaluation was measured using a catalyst evaluator SIGU (manufactured by HORIBA, Ltd.) while causing a simulated gas of 150° C. and a simulated gas of 600° C. to flow through the honeycomb units at a space velocity (SV) of 35,000/hr, and the NOx conversion rate [%] expressed by (NO inflow−NO outflow)/(NO inflow)×100 was measured. The constituents of the simulated gases are 175 ppm of nitrogen monoxide, 175 ppm of nitrogen dioxide, 350 ppm of ammonia, 14 vol % of oxygen, 5 vol % of carbon dioxide, 10 vol % of water, and nitrogen (balance). TABLE 1 illustrates the measurement results.

TABLE 1

| | | VOLUME RATIO | | | |
|---|---|---|---|---|---|
| | | FIRST | SECOND | NOx CONVERSION RATE [%] | |
| | ZEOLITE | REGION | REGION | 150° C. | 600° C. |
| EXAMPLE 1 | SAPO | 5 | 5 | 62 | 78 |
| EXAMPLE 2 | SAPO | 7 | 3 | 65 | 73 |
| EXAMPLE 3 | SAPO | 3 | 7 | 55 | 82 |
| EXAMPLE 4 | β | 5 | 5 | 42 | 79 |
| EXAMPLE 5 | β | 7 | 3 | 46 | 76 |
| EXAMPLE 6 | β | 3 | 7 | 40 | 84 |
| EXAMPLE 7 | SAPO | 5 | 5 | 54 | 70 |
| COMPARATIVE | SAPO | 10 | 0 | 68 | 54 |
| EXAMPLE 1 | | | | | |
| COMPARATIVE | β | 0 | 10 | 18 | 85 |
| EXAMPLE 2 | | | | | |
| COMPARATIVE | SAPO | 8 | 2 | 65 | 59 |
| EXAMPLE 3 | | | | | |
| COMPARATIVE | β | 2 | 8 | 25 | 84 |
| EXAMPLE 4 | | | | | |

TABLE 1 shows that the honeycomb units 11′ (the honeycomb structures 10′) of Examples 1 through 7 maintain the NOx conversion rate at 600° C. at 70% or more while maintaining the NOx conversion rate at 150° C. at 40% or more.

Thus, it is believed that the honeycomb structure 10′ and the exhaust gas converter according to this embodiment enjoy high NOx conversion rates in both low temperature and high temperature regions because in the individual honeycomb units 11′, the mass content of the first metal is more than the mass content of the second metal in the first region A, which extends from one end of the honeycomb unit 11′ in its longitudinal direction to be approximately 30% to approximately 70% of its overall length, and the mass content of the second metal is more than the mass content of the first metal in the second region B, which is the other region different from the first region A. As a result, it is believed, the honeycomb structure 10′ and the exhaust gas converter are capable of improving the NOx conversion rate in the SCR system.

Comparing the honeycomb structures 10′ of Examples 1 through 6 and the honeycomb structure 10′ of Example 7, it is believed to be desirable that the second region B of the honeycomb unit 11′ be positioned on the downstream side in the exhaust gas flowing direction.

In this embodiment, the measurement results are shown for the honeycomb structure 10′. It is believed, however, that the same effects can be produced with respect to the honeycomb structure 10.

Obviously, numerous modifications and variations of the present invention are possible in light of the above teachings. It is therefore to be understood that within the scope of the appended claims, the invention may be practiced otherwise than as specifically described herein.

What is claimed is:

1. A honeycomb structure comprising:
at least one honeycomb unit having a plurality of through holes defined by partition walls along a longitudinal direction of the honeycomb unit, the at least one honeycomb unit comprising:
a first region extending from one end of the honeycomb unit over approximately 30% or more and approximately 70% or less of an overall length of the honeycomb unit in the longitudinal direction;
a second region different from the first region;
an inorganic binder; and
zeolite comprising:
a first zeolite ion-exchanged with a first metal comprising at least one of Cu, Mn, and Ag and having a mass content; and
a second zeolite ion-exchanged with a second metal comprising at least one of Fe, Ti, and Co, the second metal having a mass content that is smaller than the mass content of the first metal in the first region and larger than the mass content of the first metal in the second region.

2. The honeycomb structure as claimed in claim 1, wherein:
a ratio of a mass of the first metal to a total mass of the first metal and the second metal is approximately 0.80 or more and approximately 1.00 or less in the first region, and
a ratio of a mass of the second metal to the total mass of the first metal and the second metal is approximately 0.80 or more and approximately 1.00 or less in the second region.

3. The honeycomb structure as claimed in claim 1, wherein the zeolite comprises at least one of β-zeolite, zeolite ZSM-5, and phosphate-based zeolite.

4. The honeycomb structure as claimed in claim 3, wherein the phosphate-based zeolite comprises at least one of a SAPO, a MeAPO, and a MeAPSO.

5. The honeycomb structure as claimed in claim 4, wherein the SAPO comprises at least one of a SAPO-5, a SAPO-11, and a SAPO-34.

6. The honeycomb structure as claimed in claim 1, wherein the inorganic binder comprises a solid contained in at least one of alumina sol, silica sol, titania sol, water glass, sepiolite, attapulgite, and boehmite.

7. The honeycomb structure as claimed in claim 1, wherein the honeycomb unit further comprises at least one of inorganic fibers and flakes.

8. The honeycomb structure as claimed in claim 7, wherein a content of at least one of the inorganic fibers and the flakes of the honeycomb unit is approximately 3 mass % to approximately 50 mass %.

9. The honeycomb structure as claimed in claim 7, wherein:
the inorganic fibers comprise at least one of alumina, silica, silicon carbide, silica alumina, glass, potassium titanate, and aluminum borate, and
the flakes comprise at least one of glass, muscovite, alumina, silica, and zinc oxide.

10. The honeycomb structure as claimed in claim 1, wherein the honeycomb structure comprises a plurality of honeycomb units.

11. The honeycomb structure as claimed in claim 10, wherein the honeycomb units comprise
at least one first honeycomb unit having a cross-sectional area of approximately 5 cm² to approximately 50 cm² in a cross section perpendicular to a longitudinal direction of the first honeycomb unit, and
a plurality of second honeycomb units defining a periphery of the honeycomb structure and surrounding the first honeycomb unit.

12. The honeycomb structure as claimed in claim 1, wherein the honeycomb structure comprises a single honeycomb unit.

13. The honeycomb structure as claimed in claim 1, further comprising:
a peripheral coat layer formed on a peripheral surface of the honeycomb unit.

14. The honeycomb structure as claimed in claim 1, wherein an amount of ion exchange of the first zeolite ion-exchanged with the first metal is approximately 1.0 mass % to approximately 5.0 mass %, and an amount of ion exchange of the second zeolite ion-exchanged with the second metal is approximately 1.0 mass % to approximately 5.0 mass %.

15. The honeycomb structure as claimed in claim 1, wherein the zeolite comprises primary particles and secondary particles, the primary particles or secondary particles having an average particle size of approximately 0.5 μm to approximately 10 μm.

16. The honeycomb structure as claimed in claim 1, wherein a content of the zeolite per apparent volume of the honeycomb unit is approximately 230 g/L to approximately 360 g/L.

17. The honeycomb structure as claimed in claim 1, wherein a content of the inorganic binder of the honeycomb unit is approximately 5 mass % to approximately 30 mass % as a solids content.

18. The honeycomb structure as claimed in claim 1, wherein the honeycomb unit has a porosity of approximately 25% to approximately 40%.

19. The honeycomb structure as claimed in claim 1, wherein the honeycomb unit has an opening ratio of approximately 50% to approximately 75% in a cross section perpendicular to the longitudinal direction of the honeycomb unit.

20. The honeycomb structure as claimed in claim 1, wherein a density of the through holes of the honeycomb unit in a cross section of the honeycomb unit perpendicular to the longitudinal direction of the honeycomb unit is approximately 31 cells/cm² to approximately 124 cells/cm².

21. The honeycomb structure as claimed in claim 1, wherein the partition walls of the honeycomb unit are approximately 0.10 mm to approximately 0.50 mm in thickness.

22. The honeycomb structure as claimed in claim 1, wherein the honeycomb unit is so constructed as to be obtained by firing at approximately 600° C. to approximately 1200° C.

23. The honeycomb structure as claimed in claim 1, wherein the honeycomb structure is so constructed as to be used in an SCR system.

24. An exhaust gas converter comprising:
the honeycomb structure as set forth in claim 1.

25. The exhaust gas converter as claimed in claim 24, wherein the second region of the honeycomb unit included in the honeycomb structure is positioned on a downstream side in a direction in which an exhaust gas flows in the exhaust gas converter.

26. The exhaust gas converter as claimed in claim 24, wherein the honeycomb structure is canned in a metal pipe with a holding sealing member provided around the honeycomb structure.

27. The exhaust gas converter as claimed in claim 24, further comprising:
an ejecting part to eject one of ammonia and a precursor of the ammonia, the ejecting part being provided on an upstream side of the honeycomb structure in a direction in which an exhaust gas flows in the exhaust gas converter.

28. The exhaust gas converter as claimed in claim 27, wherein the precursor of the ammonia comprises urea water.

29. The exhaust gas converter as claimed in claim 24, wherein:
a ratio of a mass of the first metal to a total mass of the first metal and the second metal is approximately 0.80 or more and approximately 1.00 or less in the first region, and
a ratio of a mass of the second metal to the total mass of the first metal and the second metal is approximately 0.80 or more and approximately 1.00 or less in the second region.

30. The exhaust gas converter as claimed in claim 24, wherein the zeolite comprises at least one of β-zeolite, zeolite ZSM-5, and phosphate-based zeolite.

31. The exhaust gas converter as claimed in claim 30, wherein the phosphate-based zeolite comprises at least one of a SAPO, a MeAPO, and a MeAPSO.

32. The exhaust gas converter as claimed in claim 31, wherein the SAPO comprises at least one of a SAPO-5, a SAPO-11, and a SAPO-34.

33. The exhaust gas converter as claimed in claim 24, wherein the inorganic binder comprises a solid contained in at least one of alumina sol, silica sol, titania sol, water glass, sepiolite, attapulgite, and boehmite.

34. The exhaust gas converter as claimed in claim 24, wherein the honeycomb unit further comprises at least one of inorganic fibers and flakes.

35. The exhaust gas converter as claimed in claim 34, wherein a content of at least one of the inorganic fibers and the flakes of the honeycomb unit is approximately 3 mass % to approximately 50 mass %.

36. The exhaust gas converter as claimed in claim 34, wherein:
the inorganic fibers comprise at least one of alumina, silica, silicon carbide, silica alumina, glass, potassium titanate, and aluminum borate, and
the flakes comprise at least one of glass, muscovite, alumina, silica, and zinc oxide.

37. The exhaust gas converter as claimed in claim 24, wherein the honeycomb structure comprises a plurality of honeycomb units.

38. The exhaust gas converter as claimed in claim 37, wherein the honeycomb units comprise
at least one first honeycomb unit having a cross-sectional area of approximately 5 cm² to approximately 50 cm² in a cross section perpendicular to a longitudinal direction of the first honeycomb unit, and
a plurality of second honeycomb units defining a periphery of the honeycomb structure and surrounding the first honeycomb unit.

39. The exhaust gas converter as claimed in claim 24, wherein the honeycomb structure comprises a single honeycomb unit.

40. The exhaust gas converter as claimed in claim 24, wherein the honeycomb structure further comprises a peripheral coat layer formed on a peripheral surface of the honeycomb unit.

41. The exhaust gas converter as claimed in claim 24, wherein an amount of ion exchange of the first zeolite ion-exchanged with the first metal is approximately 1.0 mass % to approximately 5.0 mass %, and an amount of ion exchange of the second zeolite ion-exchanged with the second metal is approximately 1.0 mass % to approximately 5.0 mass %.

42. The exhaust gas converter as claimed in claim 24, wherein the zeolite comprises primary particles and secondary particles, the primary particles or secondary particles having an average particle size of approximately 0.5 μm to approximately 10 μm.

43. The exhaust gas converter as claimed in claim 24, wherein a content of the zeolite per apparent volume of the honeycomb unit is approximately 230 g/L to approximately 360 g/L.

44. The exhaust gas converter as claimed in claim 24, wherein a content of the inorganic binder of the honeycomb unit is approximately 5 mass % to approximately 30 mass % as a solids content.

45. The exhaust gas converter as claimed in claim 24, wherein the honeycomb unit has a porosity of approximately 25% to approximately 40%.

46. The exhaust gas converter as claimed in claim 24, wherein the honeycomb unit has an opening ratio of approximately 50% to approximately 75% in a cross section perpendicular to the longitudinal direction of the honeycomb unit.

47. The exhaust gas converter as claimed in claim 24, wherein a density of the through holes of the honeycomb unit in a cross section of the honeycomb unit perpendicular to the longitudinal direction of the honeycomb unit is approximately 31 cells/cm² to approximately 124 cells/cm².

48. The exhaust gas converter as claimed in claim 24, wherein the partition walls of the honeycomb unit are approximately 0.10 mm to approximately 0.50 mm in thickness.

49. The exhaust gas converter as claimed in claim 24, wherein the honeycomb unit is so constructed as to be obtained by firing at approximately 600° C. to approximately 1200° C.

50. The exhaust gas converter as claimed in claim 24, wherein the exhaust gas converter is so constructed as to be used in an SCR system.
